(19) United States
(12) Patent Application Publication
(10) Pub. No.: US 2022/0019874 A1
(43) Pub. Date: Jan. 20, 2022

(54) METHOD, DEVICE, AND COMPUTER PROGRAM FOR OPERATING A DEEP NEURAL NETWORK

(71) Applicant: Robert Bosch GmbH, Stuttgart (DE)

(72) Inventors: Thomas Pfeil, Renningen (DE); Volker Fischer, Renningen (DE)

(21) Appl. No.: 17/429,105

(22) PCT Filed: Mar. 24, 2020
(86) PCT No.: PCT/EP2020/058191

§ 371 Date: Aug. 6, 2021

(30) Foreign Application Priority Data
Apr. 9, 2019 (DE) 102019205081.6

(51) Int. Cl. G06N 3/04; G06N 3/08

(52) U.S. Cl. CPC G06N 3/04; G06N 3/08

(57) ABSTRACT

A method for operating a deep neural network having at least one skip connection. The method includes: selecting a first path through the deep neural network along the specifiable sequence, using the skip connection; propagating an input variable along the first path; checking whether the output variable corresponds to a specifiable criterion, such that if the specifiable criterion is not met a further path through the deep neural network is selected that is longer by at least one layer than the first path, and the input variable is thereupon propagated along the second path with reuse of the intermediate results of the first path. A computer program, a device for carrying out the method, and a machine-readable storage element on which the computer program is stored, are also described.

### FIELD

The present invention relates to a method for operating a deep neural network. The present invention also relates to a device and to a computer program that are each configured to carry out the method.

### BACKGROUND INFORMATION

In their paper “The streaming rollout of deep networks—towards fully model-parallel execution,” in Advances in Neural Information Processing Systems (pp. 4043-4054), the authors Fischer, V., Köhler, J., and Pfeil, T. describe a method for enabling deep neural networks to be operated in completely parallel fashion.

German Patent Application No. DE 20 2018 104 373 describes a device for carrying out a method in which a specifiable control pattern is assigned to a machine learning system, the pattern characterizing a sequence according to which layers of the machine learning system ascertain their intermediate variables.

Because mobile terminal devices usually have a limited energy budget, it is desirable for as little energy as possible to be consumed during operation of deep neural networks on these terminal devices. The advantage of the method according to the present invention is that the deep neural networks can be carried out at least partly successively in order to save energy while nonetheless providing accurate results. A further advantage of the method according to the present invention is that a deep neural network that is executed successively requires less memory than a plurality of deep neural networks that are optimized for respective (energy or time) budgets. An advantage of the at least partly successive execution of the deep neural network is a low latency of input signals to output signals. The first “coarse” result is then refined through the addition of further paths.

### SUMMARY

In a first aspect of the present invention, a method, in particular computer-implemented, is provided for operating a deep neural network having at least one skip connection. In accordance with an example embodiment of the present invention, the method includes, inter alia, the steps: selecting a first path that characterizes a sequence of layers along at least a part of a specifiable sequence of the layers of the deep neural network, using the skip connection. There then follows an ascertaining of an output variable by propagation of an input variable along the first path. There then follows a check of whether the output variable corresponds to a specifiable criterion. If the specifiable criterion is not met, then a further path through the deep neural network is selected that differs from the first path, for example that is longer than the first path by at least one layer. Preferably, the second path differs from the first path in that the sequence of layers of the second path has at least one of the layers of the deep neural network that is not contained in the first path, in particular in addition to the layers of the first path. The input variable is then propagated along the second path. It is also possible for paths of the same length through the deep neural network to be selected, if its architecture enables paths having the same length.

The skip connection connects one of the layers of the deep neural network in addition to a further, in particular following, layer of the specifiable sequence in which the layers of the deep neural network are configured one after the other. In the specifiable sequence, the further layer is not a layer immediately following the layer having the skip connection.

The path, in particular a signal run path, can characterize an uninterrupted, forward-directed sequence of a plurality of layers of the deep neural network. That is, the path then characterizes how this plurality of the layers of the deep neural network are connected one after the other in order to propagate the input variable through the deep neural network, beginning at an input layer, the layer of the deep neural network that receives the input variable of the deep neural network, up to an output layer, which outputs the output variable of the deep neural network.

It is to be noted that the layers that form the respective path in each case ascertain their intermediate variable only as a function of at least one intermediate variable provided to them of at least one of the (immediately) preceding connected layers of this path. It is also to be noted that the layer of the respective path that, in the sequence of the layers of the deep neural network, is connected to more than one preceding layer ascertains its intermediate variable only as a function of the immediately preceding ascertained intermediate variable of the immediately preceding connected layer according to this path. An intermediate variable is understood as an output variable of the layer, this output variable being provided as input variable to the following connected layer.

Propagation along the path is understood as meaning that the input variable is processed by the deep neural network along the defined sequence of the layers of this path.

An advantage of this aspect is that energy is saved in the operation of the deep neural network, because not all layers of the deep neural network are required; instead, only the layers of the respective paths are used. A further advantage is that the energy requirement can be dynamically regulated according to which different paths are selected as possible paths by the deep neural network. Consequently, the depth of the deep neural network can be dynamically adapted according to specifiable conditions in order to nonetheless ensure a more reliable processing of the input variable.

In accordance with an example embodiment of the present invention, is provided that during the propagation of the input variable along the paths, those layers of the neural network that are not required for the respective path used be deactivated and that they be activated only when that layer is required for the respective path.

“Deactivated layers” can be understood as meaning that these layers do not have to be loaded from a memory, and thus do not require further resources of a computer. If the deep neural network is implemented purely in hardware, a “deactivated layer” can be understood as meaning that the associated hardware module of this layer does not execute any computing operations, even if, for example, suitable data are present at the module.

Due to the deactivation, the respective computing operations for this layer are not carried out. In this way, the deep neural network can process the input variable in a particularly energy-efficient manner.

In addition, in accordance with an example embodiment of the present invention, it is provided that during the propagation along the second path those layers by which the second path differs from the first path ascertain their intermediate variables. In addition, it is provided that, during the propagation along the second path, in addition those layers of the second path that are connected to more than one preceding layer in the deep neural network and were also contained in the first path ascertain their intermediate variables as a function of a provided intermediate variable of the respective immediately preceding connected layer of the second path and of a preceding provided intermediate variable of the immediately preceding connected layer of the first path. Advantageously, the previous provided intermediate variable is reused, i.e., is not recalculated.

The previous provided intermediate variable is that intermediate variable that was provided to this layer during the propagation of the input variable along the first path.

It is to be noted that the layers that are connected to more than one preceding layer can also be combined with already previously used intermediate variables that were ascertained along the first path, for example with a mathematical operation mean( ), max( ), add( ), concat( ).

The advantage here is that an unnecessary recalculation of the intermediate variables for the same input variable can be avoided, thus enabling an even more economical use of the limited available resources.

In addition, it is provided that the output variable be ascertained by propagation of the input variable of the deep neural network along the first and second path simultaneously.

The common layers of the first and second path can be executed exactly once on exactly one computing unit. The common layers are the layers whose respective position in the specifiable sequence of the layers of the deep neural network corresponds to the same position in the sequence of layers of the first path and in the sequence of layers of the second path.

Preferably, the intermediate variables of those layers of the remaining layers that are contained in both sequences of layers of the first and second path and that each have different positions in the sequences of layers of the first and in the second path are ascertained, when there is a repeated execution of these layers, as a function of the previous provided intermediate variable that was used in the first ascertaining of the intermediate variable according to the earlier position of the different positions of the respective layer, and as a function of the provided intermediate variable according to the later position of the different positions of the respective layer.

The layers of the first and second path each ascertain their intermediate variable on a computing unit one after the other, according to their position in a sequence of layers of the respective path. For this purpose, a time of a sequence of times at which the respective layer ascertains its intermediate variable as a function of an intermediate variable provided to it can be respectively assigned to each layer of each selected path. A plurality of different times can be assigned to those layers that are connected to more than one preceding layer. Here, the times are the times at which the layers carry out their computing operations on a computing unit. In addition, in accordance with an example embodiment of the present invention, it is provided that during the ascertaining of the output variable, the sequence of times begins and at each current time all layers of the selected paths to which the time is assigned that corresponds to the current time ascertain their intermediate variables. The layers that are connected to more than one preceding layer each ascertain, at each current time corresponding to the different times respectively assigned to them, in particular at previous times, their intermediate variable as a function of the intermediate variables present at them up to the respective time. The specifiable criterion is checked each time an output variable has been ascertained. If the criterion is not met, the execution of the processing of the layers at the respective following times is continued until the next output variable is outputted.

It is to be noted that the layers of the selected paths to which the same time has been assigned simultaneously each ascertain their intermediate variable. This has the advantageous effect that these layers are executed in parallel, thus accelerating the method.

An assignment of the times can take place in such a way that at each immediately following time, the respective immediately following connected layer, according to the path, ascertains its intermediate variable as a function of the ascertained intermediate variable of the preceding connected layer.

Here one can speak of a decoupling of the functional relationships between the layers, because the layer that is connected to more than one preceding layer does not have to wait until all required intermediate variables are present. One can therefore speak of a simultaneous operation of all paths.

Due to the fact that the neural network has only forward connections, the layers are no longer required after the ascertaining of their intermediate variable, and a plurality of input variables can advantageously be provided to the input layer at a respective time and propagated through the deep neural network. In this way, not only are the paths operated in parallel, but the input variables are also processed in parallel fashion by the deep neural network.

Advantageously, in accordance with an example embodiment of the present invention, the individual layers are executed on a respective separate computing unit, in particular on a parallel hardware unit. This permits an efficient operation, because, as explained above, the method uses the resources efficiently, and in addition an efficient execution of the individual calculations is achieved through the parallel operation of the layers.

Here a further advantage is that, given a parallel operation of the layers, a higher throughput of the input variables to be processed can be achieved, because while the input variable is propagated through the deep neural network, further input variables can already be propagated through the deep neural network. As a result, the temporal distance between an outputting of the output variables is shortened in comparison with conventional operation of the deep neural networks, and more input variables can be processed within the same time span.

Advantageously, parameters and activations of the deep neural network are quantized, the first path being the shortest path through the deep neural network.

In addition, in accordance with an example embodiment of the present invention, it is provided that each path of the deep neural network be trained separately from one another and/or that at least one group of paths be trained in common.

The advantage of this is that through the parallel optimization of a plurality of paths it can be ensured that the intermediate variables of the individual paths do not degenerate, such as for example when the complete deep neural network is trained.

It is also advantageous here that after such a training the deep neural network is more robust against a failure of a path or of a layer, because the paths have been trained separately from one another.

In addition, in accordance with an example embodiment of the present invention, it is provided that after the criterion has been met, a control variable is ascertained as a function of the output variable of the deep neural network. The control variable can be used to control an actuator of a technical system. The technical system can be, for example, an at least partly autonomous machine, an at least partly autonomous vehicle, a robot, a tool, a production machine, or a flying object such as a drone.

In a further aspect of the present invention, it is provided that the input variable of the deep neural network is a variable that was acquired by a sensor. The sensor variable is then propagated along the respective paths through the deep neural network.

In a further aspect, a computer program is provided. The computer program is configured to carry out one of the methods named above. The computer program includes instructions that cause a computer to carry out one of these named methods, with all its steps, when the computer program runs on the computer.

In addition, a machine-readable storage module is proposed on which the computer program is stored. In addition, a device is proposed that is configured to carry out one of the methods.

Exemplary embodiments of the aspects named above are shown in the figures and are explained in more detail below.

### BRIEF DESCRIPTION OF THE DRAWINGS

FIG. 1 shows a schematic representation of a deep neural network, with a plurality of paths through this deep neural network.

FIG. 2 shows a schematic representation of a parallel execution of the paths.

FIG. 3 shows a schematic representation of a specific embodiment of a method for operating the deep neural network, in accordance with the present invention.

FIG. 4 shows a schematic representation of a specific embodiment of a robot that uses the method for operating deep neural networks.

### DETAILED DESCRIPTION OF EXAMPLE EMBODIMENTS

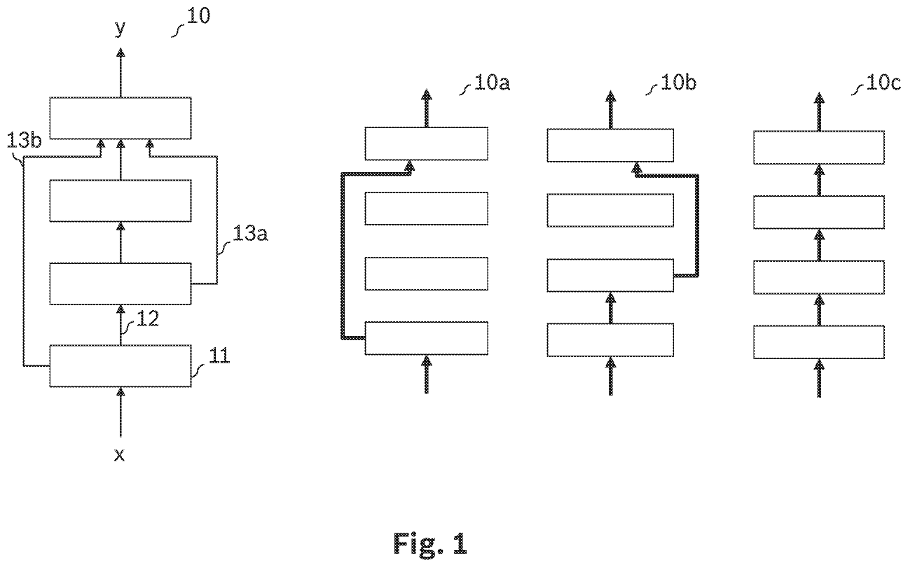

FIG. 1 shows a schematic representation of a deep neural network (10) that ascertains an output variable (y) as a function of an input variable (x). In a specific embodiment of the deep neural network (10), the deep neural network (10) ascertains a classification (y) of an image (x) as a function of the image (x). In an alternative specific embodiment, the deep neural network (10) ascertains a regression (y) as a function of the input variable (x).

As is shown in FIG. 1, the deep neural network (10) is made up of a plurality of layers (11) connected to one another via connections (12). It is to be noted that at least two layers can also be connected in parallel to one another.

The layer that receives the input variable (x) is referred to in the following as the input layer, and the layer that outputs the output variable (y) is referred to in the following as the output layer. The connections (12) can be provided with weights in order to provide the outputted intermediate variables of the respective layers to the respective connected following layer in weighted fashion.

The layers each include a plurality of neurons that each have a specifiable activation function. Alternatively, at least one of the layers is realized as a convolutional layer. In addition, in this exemplary embodiment the deep neural network (10) has two skip connections (13a, 13b). The first skip connection (13a) connects the immediately following layer of the input layer to the output layer. That is, an ascertained intermediate variable of the input layer is forwarded both to its immediately following layer and to the output layer. The second skip connection (13b) connects the input layer directly to the output layer.

Due to the skip connections (13a, 13b), a plurality of paths (10a, 10b, 10c) through the deep neural network (10) can be determined. This is shown in FIG. 1 at right next to the schematically shown deep neural network (10).

A first path (10a) through the deep neural network (10) uses only the input and output layers, which are connected to one another via the second skip connection (13b). That is, when there is a propagation of the input variable through the deep neural network (10) along the first path (10a), only the input layer and the output layer are used.

A second path (10b) through the deep neural network (10) uses the input layer, the layer immediately following the input layer, and the output layer, which are connected to one another via the connection (12) and the first skip connection (13a). The layer immediately following the input layer is referred to in the following as the second layer, and its immediately following layer is referred to as the third layer.

The difference between the first and second path is that the second path (10b) is longer by one layer than the first path (10a).

A further path (10c) can be defined by the use of each layer of the deep neural network (10), which are connected to one another only through the forward-directed connections (12).

When the input variable (x) is propagated along the first path (10a) through the deep neural network (10), an output variable (y) is present already after two time steps. This is because within a first time step the input variable (x) is processed in the input layer and is outputted as an intermediate variable. Because the first path (10a) is defined by the second skip connection (13b), the intermediate variable of the input layer is processed at the following time step by the output layer. That is, there is an output variable already after two time steps, although the overall deep neural network, due to its sequence of layers, which each require a time step for processing, thus requires overall a minimum of 4 time steps to output the output variable (y).

It is to be noted that, as shown in FIG. 1, the output layer of the deep neural network (10) ascertains the output variable (y) as a function of three intermediate variables, but, given the use of the first path (10a), ascertains it as a function of only one intermediate variable. Here the two further intermediate variables are not taken into account because the first path (10a) does not go through the layers respectively required for this.

For the case in which the input variable (x) is propagated along the second path (10b) through the deep neural network, the input layer also processes the input variable (x) in the first time step, and outputs its intermediate variable. In the second time step, the second layer ascertains its intermediate variable as a function of the intermediate variable of the input layer. Subsequently, in the third time step, based on the first skip connection (13a) the outputted intermediate variable of the second layer is processed by the output layer. That is, an output variable of the deep neural network is already present after three time steps.

The same explanation can also be used for the propagation of the input variable (x) along the third path. Here, it follows that the output variable is not present until after the fourth time step, because the input variable has to be propagated through all four layers.

Through the use of the paths, a significantly higher responsivity of the deep neural network can be achieved, because it is not necessary to wait until the input variable has been completely propagated through all of the layers up to the output.

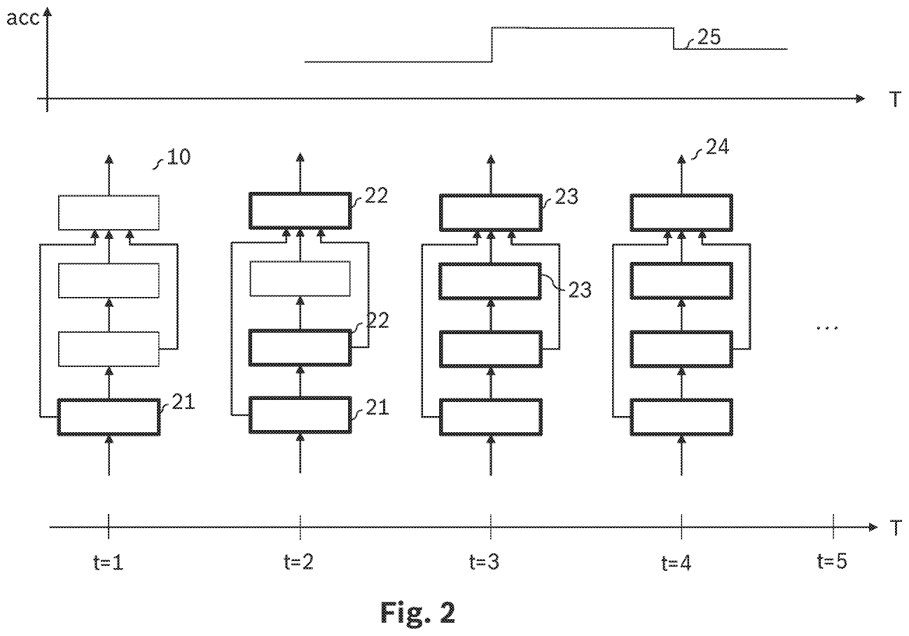

FIG. 2 shows a simplified representation of a method for the partial or completely parallel execution (streaming rollouts) of the deep neural network (10), in which the input variable is simultaneously propagated along the three paths (10a, 10b, 10c) through the deep neural network (10).

In the method for the parallel execution of the deep neural network (10), a part of the layers, or all the layers, are operated in parallel and independently of one another.

At a first time (t=1) of a sequence (T) of times, the input variable (x) is processed in the input layer, which is shown in FIG. 2 by the highlighting (21) of the input layer.

Due to the fact that the individual layers of the deep neural network (10) are operated independent of one another, at the time (t=2) immediately following the first time (t=1) this intermediate variable of the input layer is processed in the second layer and this intermediate variable is also processed in the output layer. This parallel calculation of the second layer and of the output layer are shown in FIG. 2 through the highlighting (22) of these layers. It is to be noted that the intermediate variable of the input layer is provided to the output layer through the second skip connection. That is, at the second time (t=2) the output layer ascertains the output variable (y) only as a function of the intermediate variable of the input layer.

For the case in which the deep neural network (10) classifies the input variable (x), the output layer outputs a classification whose accuracy (acc) or reliability is shown as an example in the diagram thereabove.

At the third time (t=3), the ascertained intermediate variable of the second layer is further processed both in the output layer and in the third layer. Preferably, at the third time (t=3) the output layer ascertains the output variable (y) as a function of the intermediate variable of the input layer that was already ascertained in the first time step (t=1) and as a function of the intermediate variable of the second layer. The ascertaining by the third layer of its intermediate variable at the third time (t=3) is shown in FIG. 2 by the highlighting (23). The output layer is also provided with the highlighting (23), because this layer updates the output variable as a function of the intermediate variable of the second layer.

For the case in which the deep neural network (10) carries out a classification of the input variable (x), the ascertaining of the output variable in the output layer as a function of two intermediate variables has the result that the classification will be more accurate, or more reliable. In the diagram thereabove, this is shown in that a curve (25) that describes a course of the accuracy (acc) or reliability of the output variable (y) climbs slightly.

Preferably, at the fourth time (t=4) the output layer now ascertains the output variable as a function of all intermediate variables provided to it. (This is shown in FIG. 2 by reference character 24.) Because, due to an over-parametrization of the deep neural network (10), through the use of too many layers the case can occur in which the accuracy or the reliability of the output variable degrades, in the diagram thereabove the curve falls off slightly. However, the case can also occur in which the third layer contributes further valuable information that can lead to a still more accurate classification. Consequently, the curve (25) would then climb again.

It is possible that at each time (t=1, . . . 4) the same input variable (x) be present at the input layer until all paths have been calculated. It is to be noted that, in an alternative exemplary embodiment of FIG. 2, at each time (t=2,3,4) temporally successive input variables of the deep neural network are present and can be propagated step-by-step through the deep neural network. Then, at the respective times, not only the layers that are required to process the intermediate variables that can be assigned to input variable (x) are active; rather, the layers that process the intermediate variables that can be assigned to subsequent input variables are also active. In this way, a higher degree of utilization of the deep neural network (10) can be achieved.

For the case in which the network carries out a regression instead of a classification, the curve (25) can represent, as an example, an interpolated course of the values of the input variable (y) of the deep neural network (10).

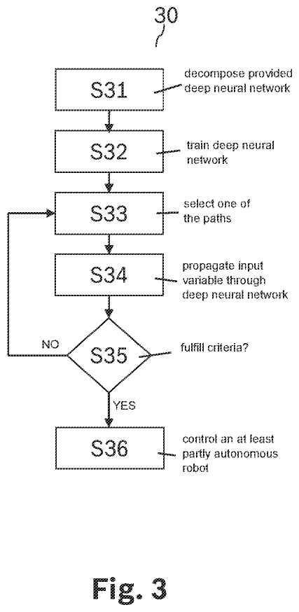

FIG. 3 shows a schematic representation of a flow diagram for carrying out the method for operating a neural network.

The method (30) begins with step S31. In step S31, a provided deep neural network having at least one skip connection, for example the deep neural network (10) according to FIG. 1, is decomposed into a plurality of paths (10a, 10b, 10c). Weights of the individual layers can be shared by the paths (10a, 10b). In addition, the paths can also be defined by a limiting of the layers to a smaller set of parameters, in particular weights.

Optionally, after step S31 step S32 can be carried out. In step S32, the deep neural network is trained. Training is understood to mean that a parametrization of the deep neural network is adapted, as a function of provided training data and labels respectively assigned to the training data, in such a way that a loss function becomes optimal with respect to a training criterion. The deep neural network can be trained by separating the individual paths, and in particular training them independently of one another. That is, for each of the paths, during the training the loss function is evaluated. This results in parallel paths of the information processing, so that when there is a disturbance in a path, the other paths can maintain the original output values of the neural network.

In addition, it is to be noted that for time series as input variables those paths that require the same number of time steps can be combined into groups, and can be provided with a loss function.

In addition or alternatively, a group of paths, or all paths, can be trained together. Here, the loss function is then made up of the individual, preferably weighted, loss functions of the individual paths.

The number of different paths used in the training can be selected corresponding to the desired granularity of the available resources.

It is also possible that already during the training, in particular shortly before the termination of the training, it is checked which paths are useful. For example, it is checked whether the use of one of the paths can contribute to improving the quality of the output variable. If it is determined that one of the paths does not contribute to an improvement, this path can be discarded, or the corresponding layer by which the path differs from the other paths can be removed from the deep neural network. The advantageous effect here is that the architecture of the deep neural network is optimized already during the training.

Alternatively or in addition, reinforcement learning can used to train the ascertaining, as a function of the input variable, of which path is the most suitable for the respective input variable.

After step S31 or the optional step S32 has ended, there follows step S33. In this step, initially one of the paths of the plurality of paths that were selected in step S31 is selected. Preferably, initially the shortest path through the deep neural network is selected, i.e., the path in which the fewest layers of the deep neural network (10) are required in order to propagate the input variable (x) through the deep neural network (10). Alternatively, the initial path, and/or, given a repeated execution of step S33, a further path can be selected, using the learned association, by the reinforcement learning of step S32. The deep neural network can then be configured according to the selected path. If the further path has been selected, the neural network can be reconfigured according to the further path. Configuration of the deep neural network can be understood as meaning that only those layers are used that belong to the respective path. It is also possible for a further neural network to be used that is configured according to the further path, so that the input variable can be propagated through the further neural network in the subsequent step.

Then, in the next following step S34, an input variable is propagated through the deep neural network, which is configured according to the selected path from step S33; see the description of FIG. 1. For example, the deep neural network is configured according to the selected path by deactivating that layer that does not belong to the first path or does not belong to one of the further paths.

In step S35, it is then checked whether an output variable of the neural network that is outputted after the propagation of the input variable in step 34 at the output of the deep neural network fulfills a specifiable criterion. For example, in the case of a classification the specifiable criterion can be that a specifiable least classification difference has to obtain between the class having the highest probability and the other classes; for example, the output value of the class having the highest output value should differ from that of the other classes by a minimum of 20%. Additionally or alternatively, it can be checked whether a specifiable resource contingent, such as an energy-time budget or memory contingent, has already been consumed by the propagation according to step S34. Preferably, the criterion therefore characterizes a threshold value, for example a confidence or variance of the output variable (y) and/or the resource contingent. In addition or alternatively, the criterion can characterize a change in the respectively outputted output variables of the different paths. If, for example, the output variable differs by less than 5%, the criterion is met.

If the criterion according to step S34 is not met (FIG. 3: branch “no”), then step S33 is carried out again, with another path from the multiplicity of the selected paths now being selected. This further path is longer by at least one layer than the previous selected path. In this way, effectively an additional layer is connected to the deep neural network that increases the expressive power of the deep neural network, with the result that a more accurate output variable, in particular an improved classification, can be ascertained. The neural network is then reconfigured according to the further path.

The further path can be drawn randomly from the set of all possible paths, or individual layers can be left out with a specified probability. Preferably, this random drawing is used during the training. During the inference, an advantage of the random drawing is that calculations can be carried out of a scatter of the output variables.

In addition, an influence can be exerted on the properties of a network through the explicit weighting, in particular via a loss term or loss function during the training, of the individual paths and/or groups of paths. For example, those paths can be particularly strongly weighted that, in isolation, are supposed to be particularly effective and/or less susceptible to disturbance. Likewise, paths can be weighted on the basis of their usage of resources, e.g. energy requirement.

The more complex the input variable (x) is, or the more resources are available, the more layers are preferably used for the calculation of the output signal, in particular longer paths.

After termination of step S33, step S34 is carried out again.

Preferably, in the repeated execution of step S34 intermediate results that were ascertained during the propagation along the first path are reused, so that parameters of the deep neural network do not have to be repeatedly loaded into the computing unit. In addition, calculations already carried out do not have to be carried out again.

If the criterion is met in step S35, there follows step S36. In step S36, for example, an at least partly autonomous robot can be controlled as a function of the output variable of the deep neural network.

In an alternative specific embodiment of the method (30), the deep neural network (10) according to FIG. 2 is operated in parallel.

Here, step S35 can be carried out each time the network outputs an output variable (y), in particular after each time step (t=2,3,4). If step S35 yields the output “no,” then the deep neural network is further operated according to the procedure of FIG. 2.

Differing from FIG. 3, in step S33 the neural network does not have to be reconfigured for the selected further path; rather, only the necessary calculations of the following time step have to be carried out, according to the described procedure of the calculations in FIG. 2. For example, if at time t=2 the check of step S35 yields the result that the output variable does not meet the criterion, then the calculations of time t=3 are carried out; i.e. the layers having highlighting (23) now carry out their calculations.

If, after step S35, it was decided that the output variable meets the criterion, then step S36 is carried out, as in FIG. 3.

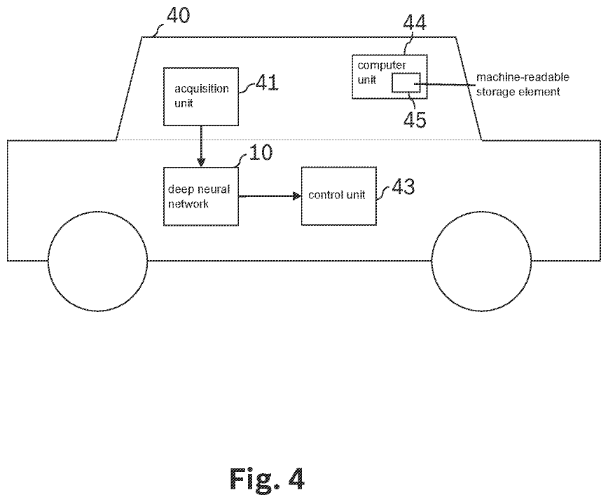

The at least partly autonomous robot is schematically represented in FIG. 4 by an at least partly autonomous vehicle (40). In a further exemplary embodiment, the at least partly autonomous robot can be a service robot, an assembly robot, or a stationary production robot, or alternatively an autonomous flying object such as a drone.

The at least partly autonomous vehicle (40) includes an acquisition unit (41). The acquisition unit (41) can be for example a camera that acquires a surrounding environment of the vehicle (40). The acquisition unit (41) is connected to the deep neural network (10). The deep neural network (10) ascertains the output variable according to the method according to FIG. 3, as a function of a provided input variable, provided by the acquisition unit (41), and as a function of a plurality of parameters. The output variable is forwarded to a control unit (43).

As a function of the output variable (y) of the deep neural network (10), the control unit (43) controls an actuator, and preferably controls this the actuator in such a way that the vehicle (40) executes a collision-free maneuver. In the first exemplary embodiment, the actuator can be an engine or a brake system of the vehicle (40). In one of the further exemplary embodiments, the partly autonomous robot may be a tool, a production machine, or a manufacturing robot. A material of a workpiece can be classified using the deep neural network (10). Here the actuator can be for example an engine that drives a grinding head.

In addition, the vehicle (40), in particular the partly autonomous robot, includes a computing unit (44) and a machine-readable storage element (45). On the storage element (45) there can be stored a computer program that includes commands that, when the commands are executed on the computing unit (44), cause the computing unit (44) to carry out the method (30) according to FIG. 3.

1-10. (canceled)

11. A method for operating a deep neural network that has at least one skip connection, the method comprising the following steps:
selecting a first path through the deep neural network along the skip connection;
ascertaining an output variable by propagating an input variable of the deep neural network along the first path;
checking whether the output variable meets a specifiable criterion; and
selecting, based on the specifiable criterion not being met, a second path through the deep neural network that differs from the first path, and ascertaining the output variable by propagating the input variable of the deep neural network along the second path.

12. The method as recited in claim 11, wherein those layers of the neural network that are not required for a respective path used being deactivated during the propagation of the input variable along the first and second paths, and not being activated until that layer is required for the respective path.

13. The method as recited in claim 11, wherein intermediate variables of those layers that were ascertained during the propagation along the first path are reused in the propagation of the input variable along the second path.

14. The method as recited in claim 13, wherein only the intermediate variables of those layers by which the second path differs from the first path are ascertained during the propagation along the second path, and those layers of the second path that are connected to more than one preceding layer and were also contained in the first path ascertaining, during the propagation along the second path, their intermediate variables as a function of a provided intermediate variable of the respective immediately preceding connected layer of the second path and of a preceding provided intermediate variable of the immediately preceding connected layer of the first path.

15. The method as recited in claim 11, further comprising the following steps:
providing a plurality of different paths through the deep neural network;
selecting at least the first path and the second path from the plurality of different paths;
ascertaining the output variable by propagating the input variable of the deep neural network simultaneously along at least the first path and the second path, intermediate variables of common layers of the first path and second path being first ascertained, in succession, up to the layer starting from which a sequence of the layers of the first and second paths differ;
ascertaining intermediate variables of those remaining layers of the first path and of those remaining layers of the second path that have a same position in the sequence of layers of the first and second paths, respectively ascertained in parallel;
checking the specifiable criterion when the output variable of the first path is outputted; and
continuing the propagation when the criterion is not met until the output variable of the second path is outputted.

16. The method as recited in claim 11, wherein: (i) the selection of the first and second paths is a function of the input variable and/or a function of a specifiable energy/time contingent that has a maximum permissible consumption level in order to propagate the input variable through the deep neural network, and/or (ii) the specifiable criterion characterizes a specifiable minimum accuracy or reliability of the output variable.

17. The method as recited in claim 11, wherein each path of the deep neural network is trained separately from one another, and/or at least one group of paths is trained in common.

18. A device configured to operate a deep neural network that has at least one skip connection, the device configured to:
select a first path through the deep neural network along the skip connection;
ascertain an output variable by propagating an input variable of the deep neural network along the first path;
check whether the output variable meets a specifiable criterion; and
select, based on the specifiable criterion not being met, a second path through the deep neural network that differs from the first path, and ascertain the output variable by propagating the input variable of the deep neural network along the second path.

19. A non-transitory machine-readable storage element on which is stored a computer program for operating a deep neural network that has at least one skip connection, the computer program, when executed by a computer, causing the computer to perform the following steps:
selecting a first path through the deep neural network along the skip connection;
ascertaining an output variable by propagating an input variable of the deep neural network along the first path;
checking whether the output variable meets a specifiable criterion; and
selecting, based on the specifiable criterion not being met, a second path through the deep neural network that differs from the first path, and ascertaining the output variable by propagating the input variable of the deep neural network along the second path.
